(19) United States
(12) Patent Application Publication
(10) Pub. No.: US 2023/0080097 A1
(43) Pub. Date: Mar. 16, 2023

(54) METHOD FOR TRANSSHIPPING LOAD CARRIERS BETWEEN ROAD AND RAIL

(71) Applicant: Jörg Salomon, Bonn (DE)

(72) Inventor: Jörg Salomon, Bonn (DE)

(73) Assignee: Deutsche Post AG, Bonn (DE)

(21) Appl. No.: 17/941,658

(22) Filed: Sep. 9, 2022

(30) Foreign Application Priority Data
Sep. 10, 2021 (DE) 10 2021 123 508.1

(51) Int. Cl. B65G 63/02; B61K 13/00

(52) U.S. Cl. CPC B65G 63/025; B61K 13/00

(57) ABSTRACT

The method disclosed for transshipping load carriers between road and rail including a loading station. The loading station includes a platform, where a series of load carriers are temporarily stored; a road; and a track. Further, to reduce the time and logistics required, a train is provided with load carriers for loading at predetermined points. Before the train drives up, information is provided regarding the points of the train by the load carriers. The truck drives up to the platform and the load carrier is transferred to sections of the platform corresponding to the points of the train. The load carriers are temporarily stored at the sections of the platform until the train drives up. When the train stops, the load carriers are transferred to the train at points of the train provided for loading by load carriers in a direction transverse to the longitudinal extension of the platform.

### CROSS-REFERENCE TO RELATED PATENT APPLICATION

This patent application claims priority to German Patent Application No. 10 2021 123 508.1, filed Sep. 10, 2022, the entire teachings and disclosures of which are incorporated herein by reference thereto.

### FIELD

The invention relates to a method for transshipping load carriers between road and rail.

### BACKGROUND

Different methods for transshipping load carriers from road to rail and back are already known. The load carriers are those with a loading space for the load to be received therein and more or less standardized dimensions. In this context, ISO containers, which are also referred to as shipping or sea containers, are particularly common. The ISO containers typically have a length of 20 or 40 feet. In addition to ISO containers, swap bodies are also often used for transporting goods on land, which have similar fastening corners at the same longitudinal distances as 20-foot ISO containers, but are slightly wider than the ISO containers, as the swap containers are specially adapted to receive Euro pallets. In rare cases, entire semitrailers are transferred as load carriers.

ISO containers and swap bodies can be easily transshipped using gantry cranes and thereby transferred from one vehicle to another. However, this requires a considerable amount of time and logistics. This effort is acceptable when loading container ships, but poses considerable problems for transshipping load carriers between road and rail. In the case of transshipping between road and rail, many trucks and trains are to be loaded and unloaded as quickly as possible.

In order to avoid temporarily storing load carriers in their entirety, it has been suggested for the load carriers to be transferred directly from a truck to a train and back again. However, this also requires a considerable amount of time and logistics. Therefore, such methods can only be used satisfactorily for certain applications.

Platforms have also been proposed on which load carriers can be temporarily stored and which are provided between a road and a track. Trucks can be driven via the road to transfer and pick up the load carriers, while trains with corresponding wagons can be driven via the track for the same purpose. The road and the track thereby run in sections parallel to the longitudinal extension of the platform. This eliminates the temporary stacking of load carriers, which is typically provided for when using gantry cranes. However, a great deal of flexibility for transshipping load carriers is also lost. This can only be compensated by delivering the load carriers “just in time” or by sorting the load carriers on the platform for subsequent onward transport. The platforms must therefore be at least twice as wide as the load carriers and the platforms must have corresponding sorting devices for the load carriers in the horizontal, i.e. in the longitudinal extension of the platform and transverse to the longitudinal extension of the platform.

As a result, the methods for transshipping load carriers having a loading station comprising at least one platform for temporarily storing a series of load carriers in the longitudinal direction of the platform, having at least one road for trucks to drive up on one side of the platform and at least one track for a train to drive up on the other side of the platform, are not yet satisfactory in terms of the time and logistics required.

### BRIEF SUMMARY

Therefore, the object underlying the present invention is to design and further develop the method of the type mentioned at the outset and explained in more detail such that the time and logistical effort required can be reduced.

This object is achieved according to claim 1 by a method for transshipping load carriers, in particular swap bodies and ISO containers, between road and rail, having a loading station comprising at least one platform for temporarily storing a series of load carriers in the longitudinal direction of the platform, having at least one road for trucks to drive up on one side of the platform and at least one track for a train to drive up on the other side of the platform,
in which the train is provided with load carriers at predetermined points along its longitudinal extension for loading,
in which the loading station and/or an operator of the loading station are informed before the train drives up regarding the points of the train provided for loading by load carriers,
in which a plurality of trucks drive up to the platform one after the other via the road and in each case at least one load carrier is transferred to sections of the platform corresponding to the points of the train to be loaded in a direction transverse to the longitudinal extension of the platform,
in which the load carriers transferred from the trucks to the platforms are temporarily stored at the sections of the platforms corresponding to the points of the train to be loaded until the train drives up,
in which the train is driven up to the platform and stopped next to the platform,
in which the temporarily stored load carriers are transferred in each case to the stopped train at points of the train provided for loading by load carriers in a direction transverse to the longitudinal extension of the platform.

Loading a train is particularly expedient because it is already known before the train arrives at the at least one platform of the loading station at which points of the train it is to be loaded and which load carriers are provided for loading the train. Before the train even arrives at the at least one platform, it can be determined which load carrier will be loaded at which point of the train. Overall, this can simplify the logistics because it is always known in advance which load carrier is located where on the train. It is then also known well in advance at which points the train is to be loaded in a loading station, even if the train has previously called at further loading stations. As a result, there may be a long period of time available for the delivery of the load carriers to be loaded. The delivery and transfer of the load carriers to the train can therefore be decoupled significantly more strongly in terms of time if exactly one load carrier is already assigned in advance to the points of the train to be loaded. However, such an assignment is not absolutely necessary.

Consequently, the loading station and/or the operator of the loading station are informed regarding which points of the train are provided for loading by load carriers along the longitudinal extension of the train. This information can be used to determine on which sections of the platform the load carriers must be temporarily stored in their longitudinal extension in order to be able to be transferred to the train in a direction transverse to the longitudinal extension of the platform after the train has driven up to the platform. It is then not necessary to move the load carriers in the longitudinal direction of the platform or to repeatedly manoeuvre the train driven up to the platform. This significantly speeds up the transshipping of the load carriers.

A decoupling between the transport of the load carriers by means of trucks and the picking-up of the load carriers by a train can also be achieved insofar as a plurality of trucks can deliver load carriers to the platform one after the other. The load carriers are then transferred to sections of the platform in a direction transverse to the longitudinal extension of the platform, which correspond to the points of the train to be loaded. This can be done long before the train arrives at the platform, if necessary. This means that the trucks do not have to remain at the platform for longer than the actual transfer of the load carriers, but rather can be used immediately for further transport tasks. The same applies to the train, as it does not have to wait for the arrival of the trucks from which load carriers are to be picked up.

The train also picks up the load carriers very quickly because they are only transferred from the platform to the train in one direction transverse to the platform. Moving the load carriers along the platform is at least substantially unnecessary if the direction transverse to the platform corresponds to the direction perpendicular to the longitudinal extension of the platform, which is preferred for simplicity. However, minor deviations from this are conceivable. For the sake of simplicity, it is also preferred for the load carriers to be picked up from the platform in the same direction as the load carriers are transferred from the platform.

The information regarding the points of the train provided for loading by load carriers can thereby vary. It is conceivable that the train must be stopped at a predetermined point. This point may always be the same or, if necessary, be part of the corresponding information. It can then also be indicated at which specific points of the platform the load carriers to be transferred to the train are to be placed. When the train stops at the predetermined point, the train can pick up the load carriers at the points on the wagons provided for this purpose. However, the relevant information regarding the points of the train provided for loading by load carriers may also contain only information on relative distances between the points of the wagons of the train provided for loading. As a result, there is greater flexibility in terms of positioning the load carriers on the platform. If the train stops at a certain point assigned to the train, the train can pick up the load carriers at the correct points on the wagons. If necessary, a subsequent train can then be stopped at another point in order to pick up the load carriers to be picked up at the assigned points of the train. This means that the space available on the platform can be used efficiently and flexibly.

This can be particularly interesting if load carriers are to be transferred to the platform in order to be relayed to a train, which is not the next train driving up to the platform, but at least the train driving up the platform after the one next. In particular, if the platform is long enough and/or only a few load carriers are to be transferred to a train, load carriers for different trains can be temporarily stored on the platform at the same time without it being necessary to stack the load carriers for this purpose. The points at which the successive trains are stopped relative to the platform may be chosen such that two load carriers for different trains are not provided for transfer at the same section of the platform. This is easily possible because it is always known in good time at which points of the trains the load carriers should be transferred to the trains. For the sake of simplicity, however, it is also conceivable that the platform is designed to be so long that the length of the platform corresponds to a plurality of train lengths. In this way, different regions of the platform can be assigned to different trains driving up to the platform one after the other or at the same time. The transfer of the load carriers from the road to a train can then be carried out at least substantially independently of the transfer of the load carriers from the road to another train. Nevertheless, the load carriers can be picked up from one train independently of the load carriers being picked up from another train.

The loading station described above is used to load a train as described. However, this does not preclude this train or, if necessary, a train not provided for loading, from unloading a load carrier at the platform of the loading station. If required, the load carrier is then transferred to the platform transverse to the longitudinal extension thereof. The load carrier is then temporarily stored there and, if necessary, transferred at a later point to a truck driving up to the platform via the road in a direction transverse to the longitudinal extension of the platform. Alternatively or additionally, it would also be conceivable for the load carrier to be transferred from the platform to another train directly or only indirectly following it in a direction transverse to the platform. However, if the platform is used in the same regions for loading and unloading trains, the load carriers provided for loading a train and the unloaded load carriers or the load carriers of a train provided for unloading may hinder each other, in particular if they use the same section of the platform simultaneously. In order to avoid this, corresponding logistical and control effort must be undertaken, which can be accepted, however.

The use of at least one platform for transshipping load carriers also has the advantage that the track can be provided with an overhead line. The transfer of the load carriers from a platform to a train in a direction at least substantially transverse to the longitudinal extension of the platform can be achieved namely in a manner in which an excessive approach of load carriers to the overhead line of the corresponding track or even contact of the overhead line by the load carriers can be reliably excluded. This is typically not possible when using gantry cranes instead of at least one corresponding platform. Nevertheless, gantry cranes can also be used in the present case, if necessary together with the platform or independently of the platform for transshipping load carriers. This applies in particular if the at least one track does not require an overhead line.

When reference is made in the present case to the transfer of load carriers by means of a train, this means in particular that the load carriers are transferred to at least one wagon of the train. When reference is made in the present case to trucks, this means all trucks that can transport at least one load carrier to the platform or away from the platform. The load carriers can thereby also be carried so as to be detachable from a trailer or formed by a trailer, for example a semitrailer. When reference is made in the present case to a longitudinal extension of the at least one platform, the road and/or the track, this can mean that the platform, the road and/or the track extend in a straight line and parallel. However, a bent or curved longitudinal extension can also be provided, wherein the platform, the road and the track can then be bent or curved preferably in the same way or correspondingly to one another for the sake of simplicity.

In the present case, the term truck is used, although this can be understood quite broadly. For example, the truck can receive the load carrier directly or pull a trailer or semitrailer that can carry at least one load carrier. In general, a truck is understood to be one that is driven by an internal combustion engine, typically by a diesel engine or gas engine. In the present case, however, the truck can also be designed as an electric vehicle. In such a case, the invention is also particularly advantageous because electric vehicles have a limited useful life until the battery of the electric vehicles must be recharged or replaced. The reduced transshipping times are particularly expedient for the efficient use of trucks in the form of electric vehicles. Furthermore, in many cases the trucks will be moved by a driver and driven up to the platform. However, this is not mandatory. Rather, it is also conceivable that the trucks will drive at least partially autonomously. In a fully autonomous mode of operation, a driver can be dispensed with entirely, while in a partially autonomous mode of operation of the truck, the driver must perform or control certain activities. For example, the driver could drive the truck to the loading station. Once there, the truck could drive autonomously and therefore very reliably to a certain position along the platform. At this point, the truck could then transfer a load carrier to a predefined section of the platform or pick up a load carrier from a predefined section of the platform.

In the case of a first particularly preferred configuration of the method, one platform is provided in the loading station in each case on both sides of the track for temporarily storing a series of load carriers in the longitudinal direction of the platform. This makes it possible to use one platform to load the trains and the other platform to unload the trains. However, greater flexibility and therefore higher performance density can be achieved if both platforms are used to load trains and/or unload trains. This flexibility can be used to achieve a high performance density because the loading station or an operator of the loading station receives information regarding the points provided for loading by load carriers.

If necessary, the loading station or an operator of the loading station can also be informed regarding the points of the load carriers provided for unloading. Thus, at any point in the method, other sections can be assigned to the load carriers to be temporarily stored on the at least one platform such that there can be no collision or obstruction of the load carriers with one another.

Moreover, it is particularly expedient if a road for trucks to drive up is provided on the two sides of the platforms facing away from the track. In this case, a large number of load carriers can be transported by trucks to the loading station in a short time in order to be relayed to at least one train. Alternatively or additionally, a large number of load carriers transferred to the platforms by at least one train can be picked up and transported by trucks in a short time in order to free up the corresponding sections of the platforms again to receive other load carriers.

A plurality of trucks can thus drive up to the platforms one after the other via the two roads, which then each transfer at least one load carrier to sections of the platforms corresponding to the points of the train to be loaded in a direction transverse to the longitudinal extension of the assigned platform. Consequently, more load carriers can be transshipped in a certain time interval. The load carriers are transferred from the trucks to the platforms as required, and namely to the sections of the platforms corresponding to the points of the train to be loaded. The load carriers are temporarily stored there until the train that is to pick up the load carriers drives up. The plurality of platforms provide additional suitable sections for this purpose. In order to pick up the load carriers, at least one train is driven up to the platforms and stopped next to the platforms such that the temporarily stored load carriers are transferred to points of the stopped train provided for loading by load carriers in a direction transverse to the longitudinal extension of the assigned platforms. As described, an at least partial unloading of the at least one train can also take place here, wherein the relevant load carriers are transferred to one or both platforms in a direction transverse to the longitudinal extension of the relevant platform.

If the width of the at least one platform transverse to the longitudinal extension of the platform is selected corresponding to at least substantially the width of the load carriers, space can be saved and thus the performance density of the transshipping of load carriers increased. According to the invention, the load carriers do not have to be sorted on the corresponding at least one platform. Moving load carriers past each other in the longitudinal extension of the platform is therefore unnecessary, as is the additional space required for this. The transfer of the load carriers temporarily stored on at least one platform in each case to points of the train provided for loading by load carriers in a direction transverse to the longitudinal extension of the at least one platform can take place at least substantially simultaneously. Transferring the load carriers one after the other would take longer overall. In the case of an at least partially simultaneous transfer of a plurality of load carriers to the same train, the transshipping times are shortened. It is also conceivable that in a loading station having at least one sufficiently long platform, two or more trains are loaded with load carriers at least partially simultaneously, which are each transferred to the trains in a direction transverse to the corresponding platform.

The transshipping of load carriers can be accelerated and simplified if required if the train to be loaded with load carriers at predetermined points is stopped in an unloading station. The unloading station can thereby comprise at least one platform for temporarily storing load carriers, at least one track for the train to drive up on one side of the platform and at least one road for trucks to drive up on the other side of the platform. In this case, it is generally expedient if a corresponding train is first stopped at the unloading station and then stopped at the loading station. In the unloading station, when load carriers are unloaded, points of the train are then freed up to receive other load carriers in the loading station. However, there is no strict distinction between loading only in the loading station and unloading only in the unloading station.

Rather, at least one load carrier can also be transferred to the stopped train in the unloading station in a direction transverse to the longitudinal extension of the platform on which the load carrier has been temporarily stored. Alternatively or additionally, in the loading station, at least one load carrier can be transferred from the train to the platform in a direction transverse to the longitudinal extension of the corresponding platform despite the existing unloading station. However, in the case of a loading station and an unloading station, for the sake of simplicity, the load carriers of a train are unloaded primarily in the unloading station and a train is loaded with load carriers primarily in the loading station. However, for the sake of simplicity, load carriers are picked up and relayed by means of the platforms in the loading station and the unloading station in the same way. The load carriers provided for unloading are therefore transferred to the platform at the unloading station in each case in a direction transverse to the longitudinal extension of the platform.

In order to once again free up the at least one platform of the unloading station for unloading subsequent trains after at least partially unloading a train, the load carriers transferred from the train to the platform at the unloading station can be transferred one after the other to a plurality of trucks in a direction transverse to the longitudinal extension of the platform. They then take the load carriers away. In order to increase the performance density in this case, it may be that at least one load carrier picked up by a truck in the unloading station can be moved to the loading station. There, the load carrier can then be transferred to the platform of the loading station as a load carrier to be picked up by another train in a direction transverse to the longitudinal extension of the platform of the loading station. The load carrier is then temporarily stored in this section of the platform until the load carrier is transferred from the platform to a train provided for this purpose in a direction transverse to the longitudinal extension of the platform. However, it can also be provided that a load carrier transferred from a train in the unloading station to the platform is transferred to a subsequent train without further reloading or moving, and namely from the same section of the platform in a direction transverse to the longitudinal extension of the platform.

In order to increase the performance density of the transshipping of load carriers, it may be appropriate to provide, in the unloading station, a platform in each case on both sides of the track for temporarily storing a series of load carriers in the longitudinal direction of the platform. Unloading can then take place more flexibly. If, for example, a load carrier cannot be unloaded at one side because there is already a load carrier in the relevant section of the relevant platform, the load carrier of the train can, if necessary, be picked up from the platform at the other side in a direction transverse to the longitudinal extension of the platform there. This makes it easy to compensate for possible delays in individual trucks. This means that trucks may run the risk of being delayed and may therefore be used for longer for the actual transport. This would not be possible in the same way if trucks always had to plan a certain waiting time at the unloading station. Consequently, it will generally be preferable for a road for trucks to drive up to be provided in each case at the sides of the platforms facing away from the track.

However, this is not mandatory. A load carrier unloaded by a train in the unloading station and transferred to the adjacent platform can also be picked up by another train, which can be stopped on the other side of the platform, in a direction transverse to the longitudinal extension of the corresponding platform. Consequently, it may be preferable if, at the sides of the platforms facing away from the track, a road for trucks to drive up is provided and a track for a train to drive up is provided. In rare cases, it is also conceivable that three tracks, each with a platform between two adjacent tracks, are provided in the unloading station. The same generally applies to the loading station.

If the load carriers provided for unloading are each transferred to the platforms at the unloading station in a direction transverse to the longitudinal extension of the associated platform, the platforms can be used particularly expediently to simplify and accelerate the transshipping of the load carriers. This applies alternatively or additionally if the load carriers transferred from the train to the platforms at the unloading station are transferred one after the other to a plurality of trucks in a direction transverse to the longitudinal extension of the assigned platform.

In order to use the unloading station as efficiently as possible and to increase the performance density of the transshipping of load carriers, load carriers provided for loading in the unloading station can be driven up to the at least one platform by at least one truck and transferred to the associated platform in a direction transverse to the longitudinal extension of the associated platform. The load carriers can then be loaded onto a train in the unloading station if, at the corresponding point of a platform of the loading station, a section of the platform is already occupied by another load carrier, which should first be loaded onto one of the subsequent trains. The load carriers provided for loading and transferred to the at least one platform in the unloading station can be transferred to the train stopped in the unloading station in a direction transverse to the longitudinal extension of the at least one platform. This can be done easily, quickly and reliably.

Flexibility and, if necessary, performance density can also be increased in the loading station by two tracks being provided in the loading station for a train to drive up in each case. A platform can then be provided between the two tracks. This means that more trains can be involved in the transshipping of the load carriers and that load carriers can be transferred directly via the platform provided between the tracks from a train stopped on one track to another train stopped, if necessary later, on the other track. To further increase flexibility and performance density, one platform can be provided on each side of the two tracks facing away from the platform between the two tracks. Consequently, at least three platforms are thus provided in the loading station, which can be used for temporarily storing load carriers occasionally.

In order to achieve a good connection between the two tracks and the load carrier transport via public road traffic so that a greater transshipping volume of load carriers is achieved, it is also advisable if, a road for trucks to drive up is provided in each case on the sides, facing away from the two tracks, of the platforms provided at each side of the tracks. The three platforms and two tracks are then enclosed on both sides by roads for trucks to drive up to the outer platforms. If this is sufficient, however, only one road adjoining one of the outer platforms would be conceivable.

In order that intensive transshipping of load carriers can also take place between trains, it is advisable for load carriers provided for loading in the unloading station to be driven by a train to the at least one platform and transferred to the associated platform in a direction transverse to the longitudinal extension of the associated platform. The load carriers provided for loading and transferred from the train to the at least one platform can then be transferred in the unloading station in a direction transverse to the longitudinal extension of the at least one platform to a train subsequently stopped in the unloading station. The two trains involved in the transshipping of the load carriers can thereby share the same track or drive up on adjacent tracks to the platform which is arranged between the tracks and which is involved in the transshipping of the load carriers. The load carrier to be transferred is then transferred in a direction transverse to the longitudinal extension from one train to the next and temporarily stored on the platform, if required.

In order to increase the flexibility and, if necessary, the performance density in the unloading station, two tracks can be provided in the unloading station for one train to drive up in each case and one platform between the tracks. This means that more trains can be involved in the transshipping of the load carriers and that load carriers can also be reloaded directly via the platform provided between the tracks from a train stopped on one track to another train stopped, if necessary later, on the other track. To further increase flexibility and performance density, one platform can be provided on each side of the two tracks facing away from the platform between the two tracks. Consequently, at least three platforms are thus provided in the unloading station, which can be used for temporarily storing load carriers occasionally.

In order to improve the connection of the two tracks to the transport of load carriers via public road traffic so that a greater transshipping volume of load carriers is achieved, it is also advisable if, a road for trucks to drive up is provided in each case on the sides, facing away from the two tracks, of the platforms provided at each side of the tracks. The three platforms of the unloading station and two tracks are then enclosed on both sides by roads for trucks to drive up to the outer platforms. If this is sufficient, however, only one road adjoining one of the outer platforms would be conceivable.

The loading station can be used for the transshipping of load carriers between trains in a simple manner if, in the loading station, load carriers provided for loading are driven by a train to the at least one platform and transferred to the associated platform in a direction transverse to the longitudinal extension of the associated platform. The load carriers provided for loading and transferred from the train to the at least one platform can then be transferred in the loading station in a direction transverse to the longitudinal extension of the at least one platform to a train subsequently stopped in the loading station. The two trains involved in the transshipping of the load carriers can thereby share the same track or drive up on adjacent tracks to the platform which is arranged between the tracks and which is involved in the transshipping of the load carriers. The load carrier to be transferred is then transferred in a direction transverse to the longitudinal extension from one train to the next and temporarily stored on the platform, if required.

A further increase in flexibility with regard to the method for transshipping load carriers and thus a higher performance density can be achieved by the at least one platform extending in the longitudinal extension of the platform continuously from the unloading station to the loading station or vice versa. Consequently, no physical separation is required between the loading station and the unloading station. Rather, the unloading station can merge, more or less seamlessly, with the loading station. The loading station or unloading station can also be extended, as required, with the unloading station or loading station being shortened accordingly. As a result, the regions of the platform assigned to the loading station and to the unloading station can be varied and dynamically adapted to the respective needs.

The corresponding advantages become all the more apparent when all platforms extend in the longitudinal extension of the respective platform, continuously from the unloading station to the loading station or vice versa and/or when the at least one track and the at least one road extend along the longitudinal extension of the at least one platform continuously from the unloading station to the loading station or vice versa. This ultimately allows for a compact design of the loading station and unloading station. At the same time, high efficiency and performance density are thereby enabled with regard to the method for transshipping load carriers between road and rail.

### BRIEF DESCRIPTION OF THE DRAWINGS

The invention will be explained in greater detail below by means of a drawing merely depicting exemplary embodiments. In the drawings:

FIGS. 1A-D show a sequence of method steps of a first method according to the invention in a schematic representation;

FIGS. 2A-D show a sequence of method steps of a second method according to the invention in a schematic representation;

FIGS. 3A-B show a sequence of method steps of a third method according to the invention in a schematic representation;

FIGS. 4A-D show a sequence of method steps of a fourth method according to the invention in a schematic representation; and

FIGS. 5A-B show a sequence of method steps of a fifth method according to the invention in a schematic representation.

### DETAILED DESCRIPTION

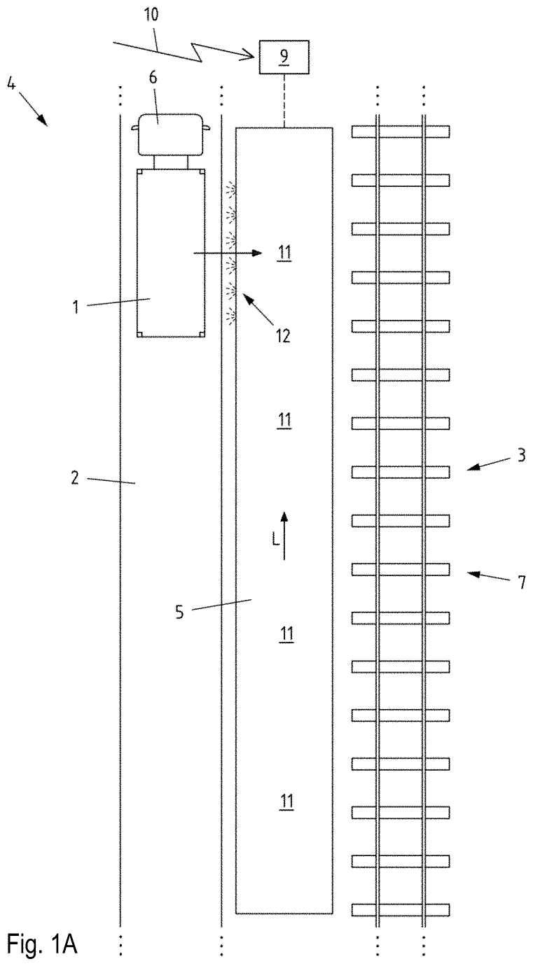

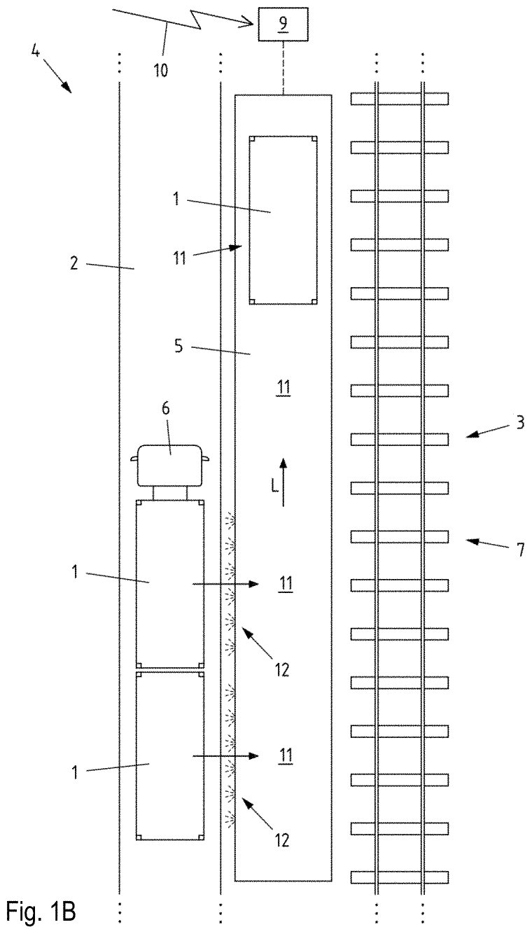

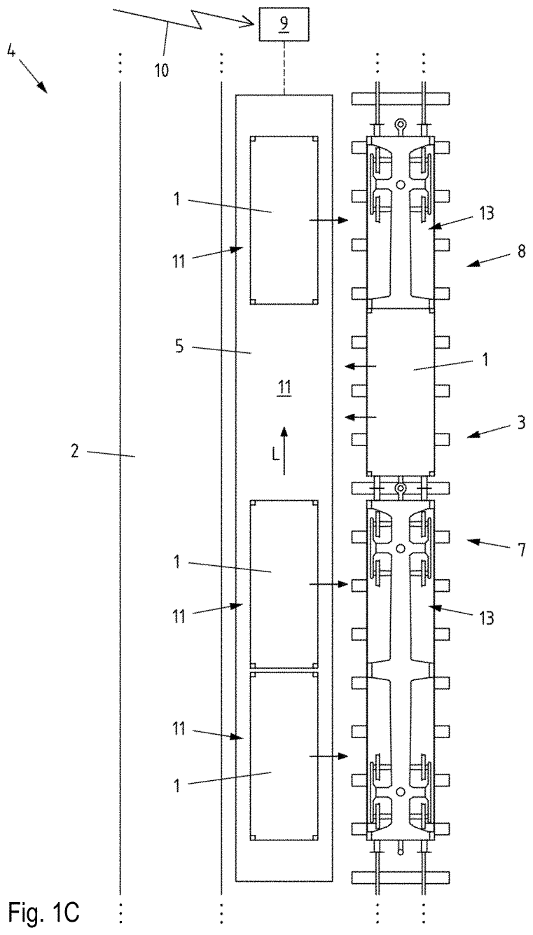

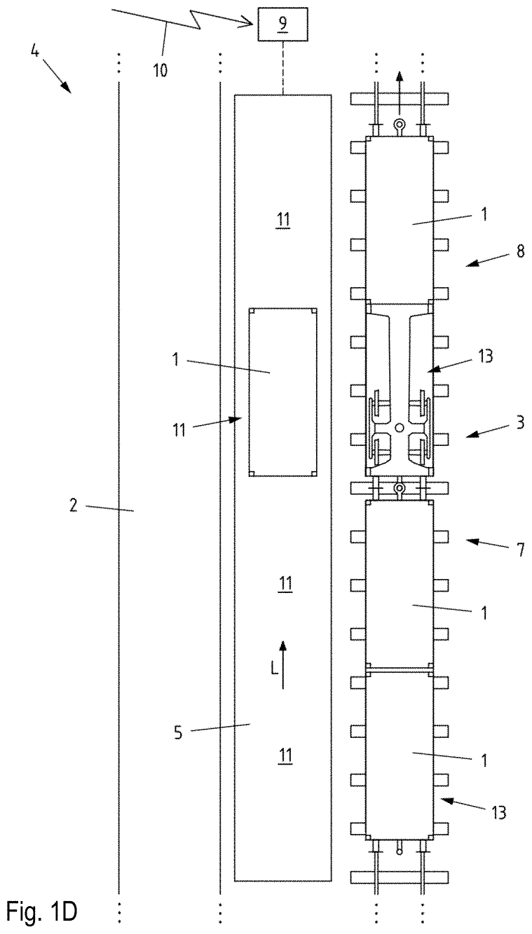

FIGS. 1A-D show a method for transshipping load carriers 1 from the road 2 to the rail 3 in a schematic sequence of individual steps. The method thereby uses a loading station 4 with a platform 5 for temporarily storing a series of load carriers 1 in the longitudinal direction L of the platform 5, with a road 2 for trucks 6 to drive up on one side of the platform 5 and a track 7 for a train 8 to drive up on the other side of the platform 5. The loading station 4 is represented in a view from above, wherein in FIG. 1A it is represented that a control unit 9 of the loading station 4 receives information 10 regarding at which points of a train 8 that has not yet arrived at the loading station 4, said train 8 can receive load carriers 1 when it has arrived at the loading station 4. This information 10 can, if required, be obtained quite early, for example before the train 8 has been loaded and/or unloaded at further, previous loading stations 4.

Based on the relevant information 10, it can be determined in which sections 11 of the platform 5 it is expedient to position on the platform 5 the load carriers 1 to be loaded onto the train 8 so that the load carriers 1 positioned there can later be transferred to the train 8 in a direction transverse to the longitudinal extension L of the platform 5. These sections 11 of the platform 5 can for example be visually identified, for example by lighting 12. The driver of a truck 6, who transports a load carrier 1 to be loaded onto the train 8 to the platform 5 via the road 2, can thus drive precisely to the section 11 of the platform 5 from which the load carrier 1 is later to be transferred to the train 8. The truck 6 is then stopped at the corresponding point of the platform 5 and transfers the load carrier 1 to the platform 5 in a direction transverse to the longitudinal extension L of the platform 5, where the load carrier 1 is temporarily stored until the corresponding train 8 arrives. The truck 6 can then be used for other transports after the load carrier 1 has been transferred.

In the same way, according to FIG. 1B, another truck 6 can be driven up to the platform 5 before the train 8 has arrived at the loading station 4 to pick up the load carriers 1. This truck 6 thereby transfers two load carriers 1 to the platform 5 and namely in each case to sections 11 of the platform 5, at which the load carriers 1 are to later be transferred to the train 8. The transfer also takes place here in a direction transverse to the longitudinal extension L of the platform 5.

When the train 8 arrives, as represented in FIG. 1C, the load carriers 1 temporarily stored on the platform 5 can be transferred to the train 8 in a direction transverse to the longitudinal extension L of the platform 5. The load carriers 1 have previously been deliberately transferred to the platform 5 in the sections 11 of the platform 5, from which the load carriers 1 can be transferred to the train 8 in a direction transverse to the longitudinal extension L of the platform 5 without this for example leading to a collision with load carriers 1 already provided on the train 8. The transfer of the load carriers 1 to the train 8 can take place at least substantially simultaneously. In addition, during, before or after loading the train 8, a load carrier 1 transported by the train 8 to the platform 5 can also be transferred from the train 8 to the platform 5 in a direction transverse to the longitudinal extension L of the platform 5. This means that the train 8 can also be unloaded in the loading station 4.

As represented in FIG. 1D, the train 8 leaves the loading station 4 after the load carriers 1 have been correspondingly transferred. In this case, a load carrier 1 remains on the platform 5 in the method represented and in this respect preferred. This load carrier 1 can be transported either by road 2 or by rail 3. In the first case, a truck 6 is driven up to the platform 5, at which point the load carrier 1 is transferred to the truck 6 in a direction transverse to the longitudinal extension L of the platform 5. The truck can be guided to the load carrier 1 to be picked up by means of an optical display, lighting 12 or similar. In the latter case, a subsequent train 8 can be stopped at a position next to the platform 5 such that a section of a wagon 13 of the train 8 is positioned next to the load carrier 1, to which the load carrier 1 can be transferred from the platform 5 to the corresponding wagon 13 of the train 8 in a direction transverse to the longitudinal extension L of the platform 5. It therefore follows that a suitable position can always be determined for each train 8 at which the train 8 is stopped in order to achieve the simplest and most efficient transfer and/or pick-up of the load carriers 1 possible without there being a conflict with the sections 11 of the platform 5 available for the load carriers 1. In this way, load carriers 1, which should only be picked up by a train 8 after next the one or even a later train, can also be picked up from platform 5. The individual trains 8 are then always stopped just at platform 5 such that the transfer of the load carriers 1 to free points on the wagons 13 can take place.

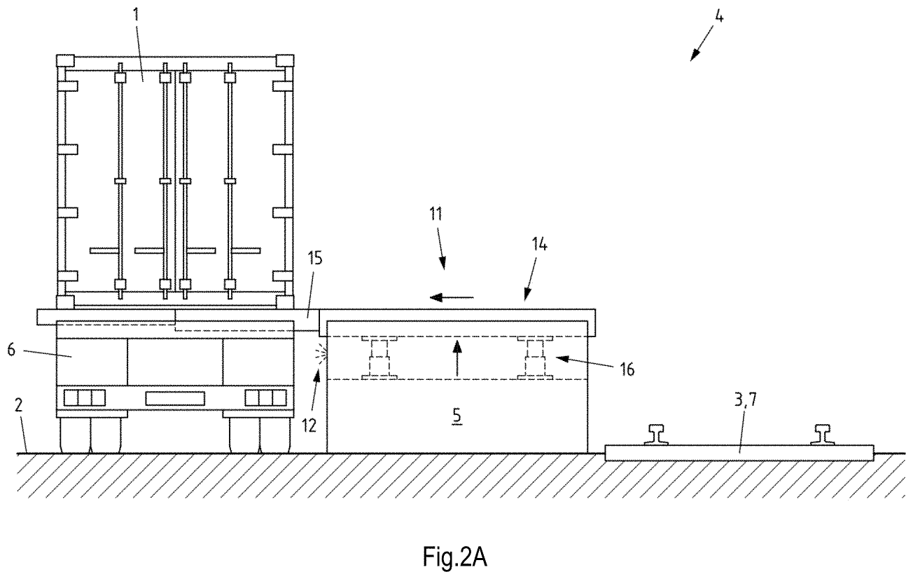

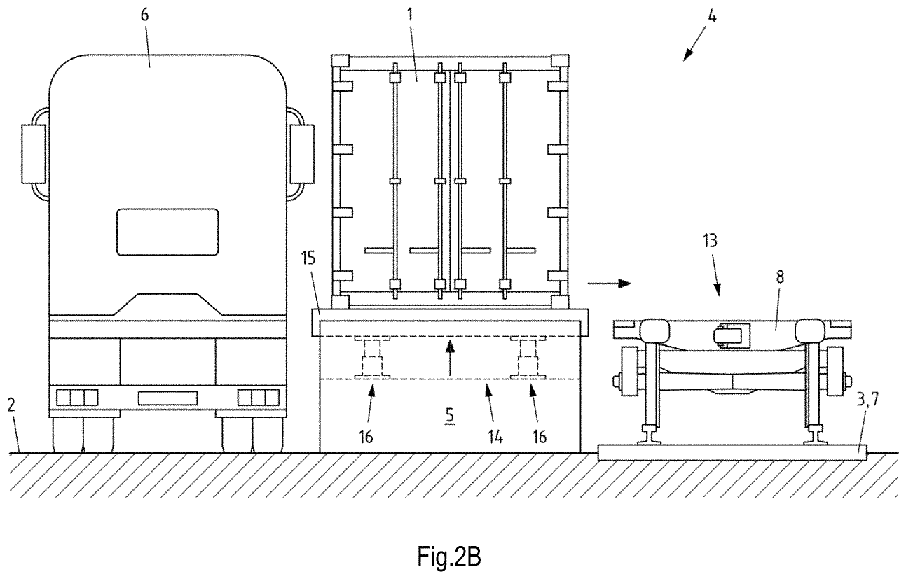

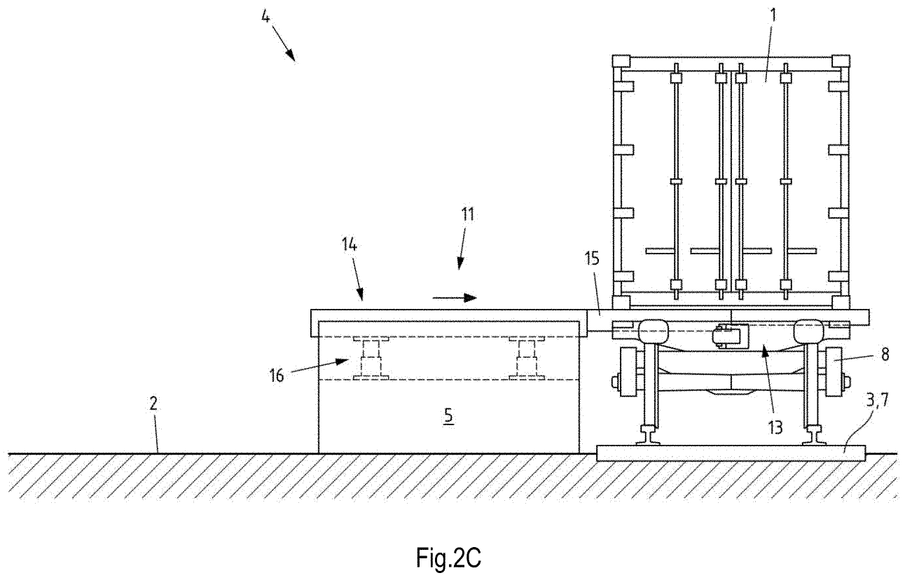

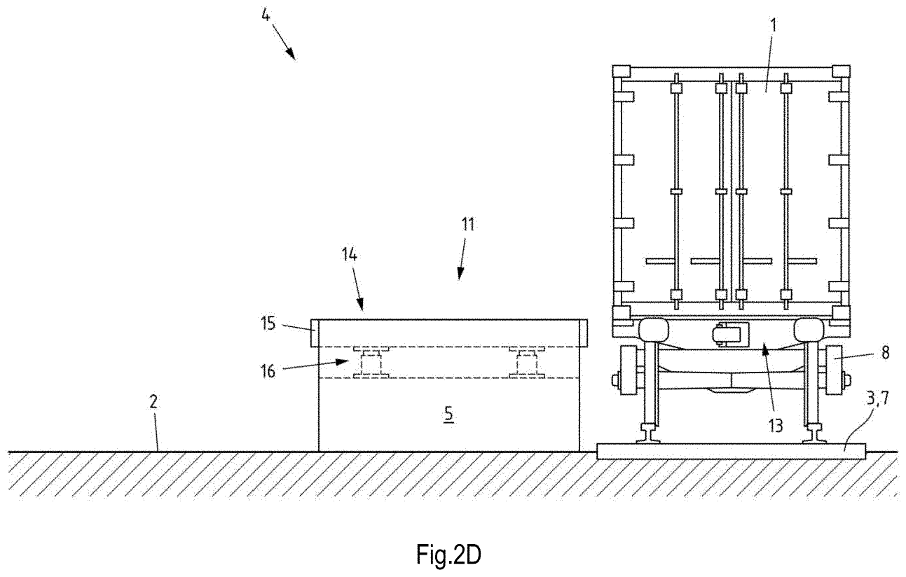

FIGS. 2A-D represent the transfer of the load carriers 1 from the truck 6 to the platform 5, on the one hand, and from the platform 5 to the train 8, on the other hand, purely schematically and by way of example. The transfer of load carriers 1 from a train 8 to a platform 5 and from the platform 5 to a truck 6 thereby takes place in the same way, only in the opposite direction. For this purpose, the platform 5 has a corresponding transport device 14, which is also only described by way of example. Other transport devices 14 are also possible, wherein the person skilled in the art can generally use already known transport devices 14. These do not therefore need to be discussed in detail in the present case.

FIG. 2A represents how a truck 6 with a load carrier 1 stops next to the platform 5, wherein a support arm 15 of the transport device 14 has been pushed laterally under the load carrier 1 from the platform 5. This support arm can lift the load carrier 1, if necessary after being previously unlocked from the truck 6, for example by means of a lifting device 16 and thus lift it off the truck 6. The support arm 15 can then be adjusted back together with the load carrier 1 until the load carrier 1 is arranged together with the support arm 15 on the platform 5. This is represented in FIG. 2B. It is not represented that the transport device 14 comprises at least one further support arm 15 which engages under the load carrier 1 at a different point in order to prevent the load carrier 1 from tipping over. The load carrier 1 can be temporarily stored in the section 11 on the platform 5 until the train 8 to which the load carrier 1 is to be transferred has arrived. In this case, two support arms 15 can be assigned to each section 11 of the platform 5 or two support arms 15 can define a section of the platform 5, since the support arms 15 can preferably not be adjusted or not significantly adjusted in the longitudinal extension L of the platform 5. In principle, however, a different number of support arms 15 or other transfer means can also be provided for each section 11 of the platform 5.

In order to transfer the load carrier 1 from the platform 5 to the train 8, the support arm 15 according to FIG. 2C together with the load carrier 1 can be extended from the platform 5 to the other side such that the load carrier 1 is arranged above a wagon 13 of the train 8. The support arm 15 can then place the load carrier 1, for example with the lifting device 16, on the wagon 13 of the train 8.

The load carrier 1 can then be locked with the wagon 13. After transferring the load carrier 1 to the train 8, the support arm 15 is pushed back onto the platform 5 so that the train 8 now loaded with the transferred load carrier 1 can move away from the platform 5, as sketched in FIG. 2D.

The load carriers 1 are transferred in the manner described or in another, if necessary similar manner, in each case in a direction transverse, in particular perpendicular, to the longitudinal extension L of the platform 5. This method makes it unnecessary to move or sort the load carriers 1 in the longitudinal extension L of the platform 5 if the control unit 9 of the loading station 4 ensures that the load carriers 1 are always temporarily stored at a suitable point, i.e. on an expedient section 11 of the platform 5.

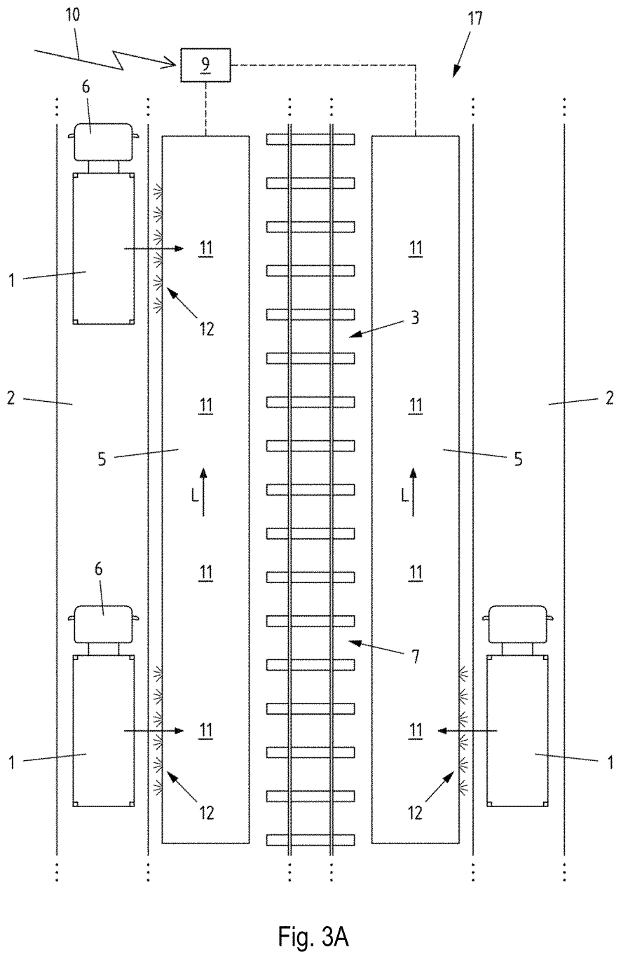

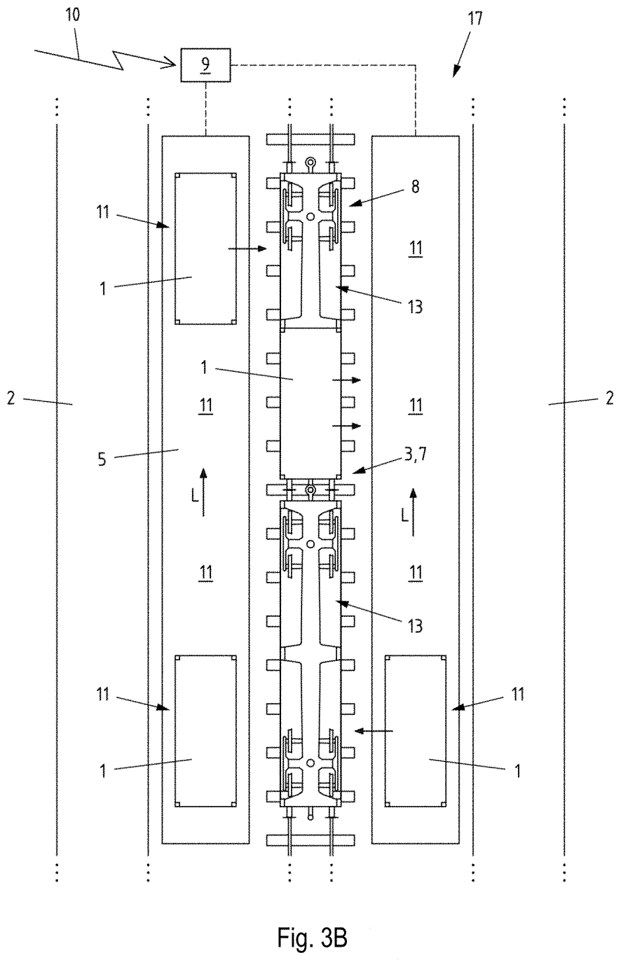

FIGS. 3A-B represent a further method for transshipping load carriers 1 having a loading station 17, in which a platform 5 is provided on both sides of the track 7 and in each case a road 2 is provided outside of the platforms 5. This configuration allows a more flexible delivery of load carriers 1 for transfer to a train 8. FIG. 3A represents three trucks 6, which each deliver a load carrier 1 to the platforms 5 and in each case transfer them to the platform 5 in a direction transverse to the longitudinal extension L of the respective platform 5. For the sake of simplicity, the trucks 6 are represented together. However, this does not mean that the trucks 6 must also be at the loading station 17 at the same time. Rather, in practice, it will generally occur that the trucks 6 arrive at the loading station 17 one after the other in order to transfer the load carriers 1 to the platforms 5. The transfer of the load carriers 1 can thereby take place in the manner already described.

Nevertheless, two trucks 6 driving up to the loading station 17 at the same time can transfer load carriers 1 to different platforms 5 such that the trucks 6 do not thereby hinder one another. In the method example represented, the load carriers 1 are also not provided for relaying to the same train 8, but rather to two trains 8 driving to the loading station 17 one after the other. The special feature here is that the two trains 8 are each to be loaded with a load carrier 1 at the same position of the loading station 17. This would only be possible with additional effort if only one platform 5 were provided. However, since two platforms 5 are provided, two load carriers 1 can be transferred to the same sections of the two platforms 5. After being transferred to the platforms 5 in a direction transverse to the longitudinal extension of the platforms 5, they are then located opposite one another in relation to the track 7.

Now, as represented in FIG. 3B, when the first train 8 moves into the loading station 17, a load carrier 1 of the two load carriers 1 arranged opposite one another on the opposite platforms 5 can be transferred to a wagon 13 of the train 8. The other of the two load carriers 1 arranged opposite one another remains on the assigned platform 5 until the following train 8 moves in and the load carrier 1 can be loaded onto this following train 8. On the train 8 represented in FIG. 3B, another load carrier 1 is transferred from another section 11 of the left platform 5 to the train 8 in a direction transverse to the longitudinal extension L of the platform 5. In addition, a load carrier 1 is transferred from the train 8 to the platform 5 in a direction transverse to the longitudinal extension L of the platform 5, even if this were not necessary. It is therefore not absolutely necessary to distinguish between loading and unloading a train 8 in the loading station 17. Individual trains 8 may also only be unloaded in the loading station 17 without the trains 8 also having to receive a load carrier 1 in the loading station 17.

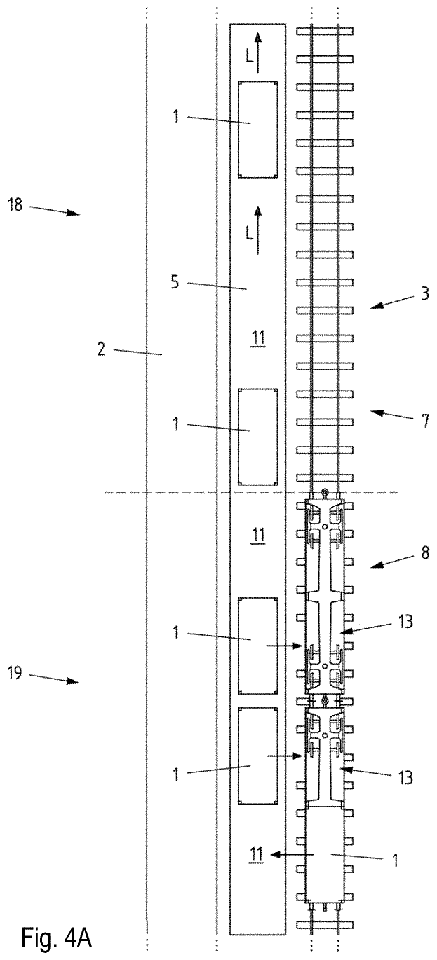

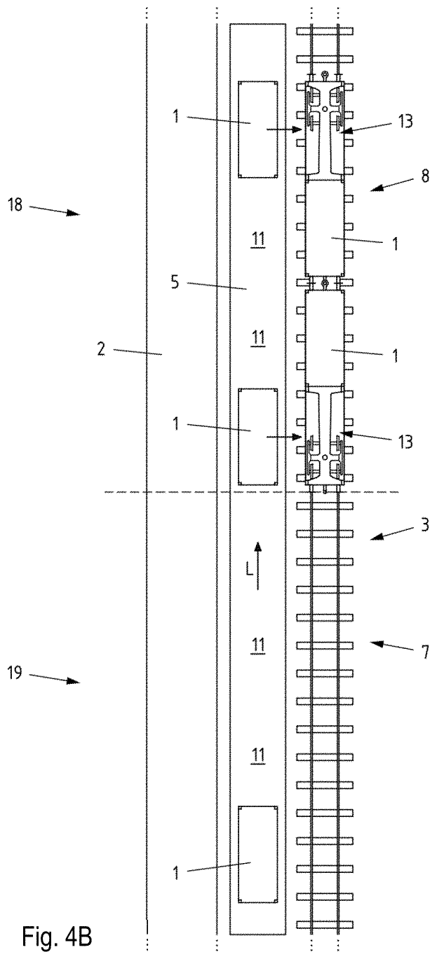

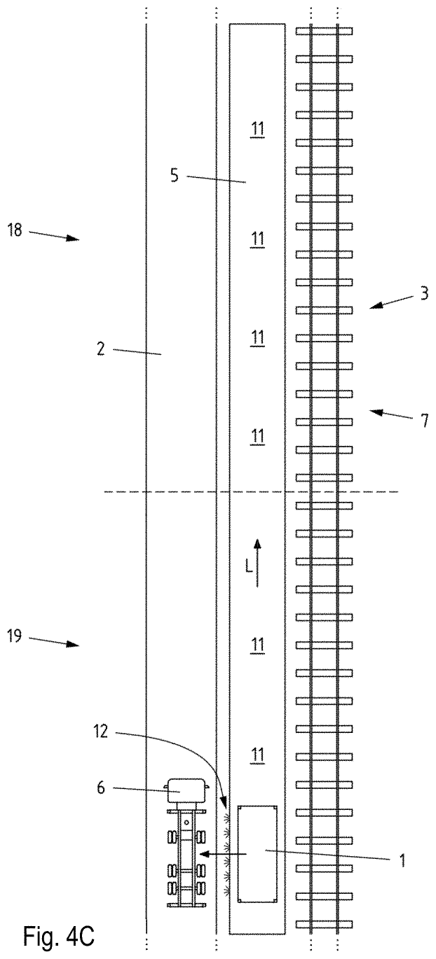

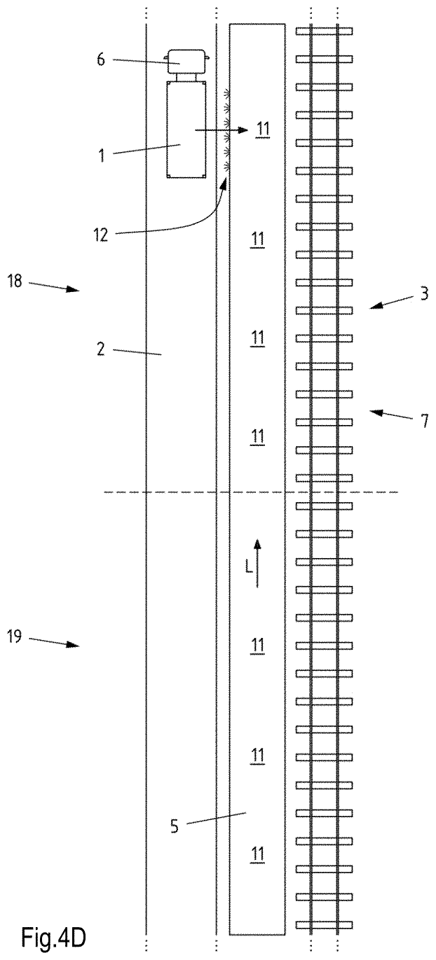

FIGS. 4A-D describe a further method for transshipping load carriers 1 having a loading station 18 and an unloading station 19. The method represented and preferred in this respect is carried out with a loading station 18 and an unloading station 19, which merge into one another in the longitudinal direction L of the platform 5. Alternatively, the loading station 18 and the unloading station 19 could also be spatially separated from one another. The represented loading station 18 and the represented unloading station 19 are designed in the same way, namely in the present case they have a track 7 and a road 2, as well as a platform 5 provided in between. However, other configurations would also be conceivable, in particular with a plurality of platforms 5, roads 2 and/or tracks 7 next to one another.

FIG. 4A represents a train 8 stopped in the unloading station 19. In this position, the train 8 transfers two load carriers 1 to the platform 5 and picks up another load carrier 1 from the platform 5, which was temporarily stored on the platform 5 in the corresponding section 11 of the platform 5. In the loading station 18 arranged above this, two further load carriers 1 are temporarily stored in different sections 11 of the platform 5 in order to be picked up by the train 8. For this purpose, the train 8 moves from the unloading station 19 to the loading station 18 and is stopped there. The platform 5 then passes the two temporarily stored load carriers 1 to the train 8, as represented in FIG. 4B. Consequently, the loading and unloading of a train 8 is at least partially decoupled in order to avoid individual load carriers 1 being hindered during loading and unloading. On the other hand, high flexibility is provided since the loading station 18 does not necessarily have to be limited to loading the train 8 and the unloading station 19 does not necessarily have to be limited to unloading the train 8.

In order to avoid the load carrier 1 transferred from the last train 8 to the platform 5 in the unloading station 19 impeding the unloading of another load carrier 1 from a subsequent train 8 to the same section 11 of the platform 5, the initially transferred load carrier 1 can be picked up by a truck 6, as represented in FIG. 4C. In this case, the truck 6 can be driven via the road 2 to a distant destination. However, it can also be provided that the load carrier 1 is only moved by the truck 6 into the loading station 18 in order to be transferred there to a predetermined section 11 of the platform 5 there, as represented in FIG. 4D. From this section 11 of the platform 5, the load carrier 1 can be picked up on a train 8 driving into the loading station 18 later such that the load carrier 1 is not taken away via the road 2, but rather via the rail 3.

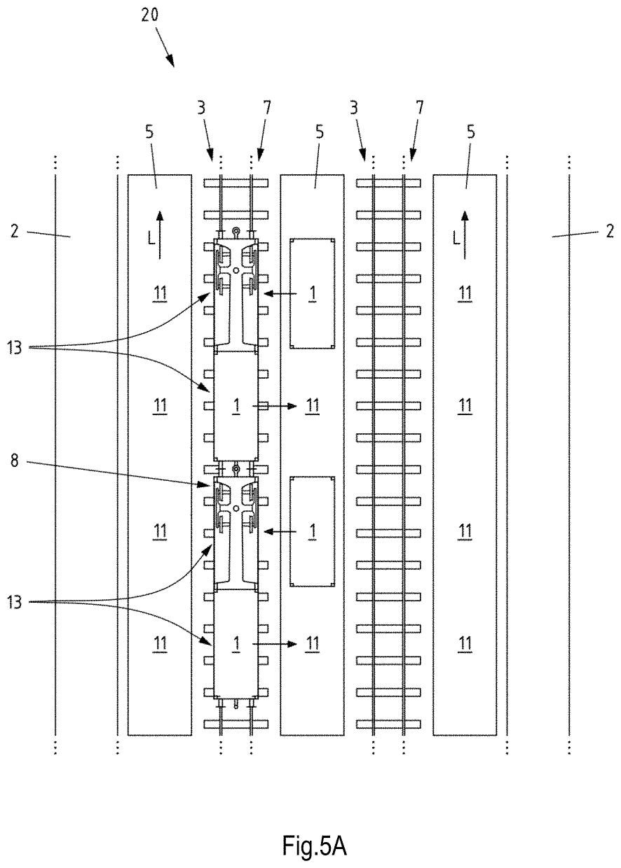

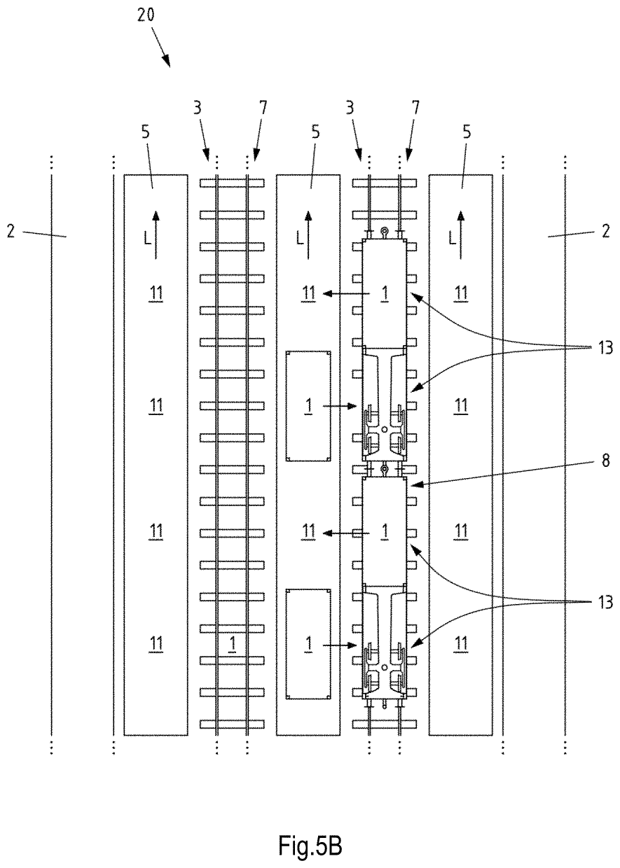

In the previously described method examples, only one track 7 was used at a time. However, there is actually no such a restriction, as represented in FIGS. 5A-B. This shows a further method for transshipping load carriers 1 with a loading station 20, in which two tracks 7 and, in the case represented and in this respect preferred, also two roads 2 and three platforms 5 provided in between are used. When transshipping load carriers 1, the previously described transfers of load carriers 1 can also take place in the case of the loading station 20 represented. The principles can be transferred from one exemplary embodiment to another exemplary embodiment. A special feature of the loading station 20 represented in FIGS. 5A-B is, however, that load carriers 1 can be picked up by a train 8 driving on a track 7 from at least one of the two adjoining platforms 5 and transferred to at least one of the two adjoining platforms S. This also includes the platform 5 provided between the two tracks 7, as represented in FIG. 5A. Accordingly, two load carriers 1 are picked up from the platform 5 and one load carrier 1 is transferred to the platform S. This load carrier 1 is then later transferred from the same platform 5 to a train 8 subsequently or simultaneously driving into the loading station 20, which in turn can deliver a load carrier 1 to the central platform 5, as represented in FIG. 5B. It is therefore possible to transfer between rail 3 and road 2, but also between rail 3 and rail 3. The transshipping of load carriers 1 can thus be made more flexible and efficient. Of course, a load carrier 1 delivered by a train 8 on a track 7 can also be picked up by another train 8 driving onto the same track 7 later.

### LIST OF REFERENCE NUMERALS

1 Load carrier
2 Road
3 Rail
4 Loading station
5 Platform
6 Truck
7 Track
8 Train
9 Control unit
10 Information
11 Section
12 Lighting
13 Wagon
14 Transport device
15 Support arm
16 Lifting device
17 Loading station
18 Loading station
19 Unloading station
20 Loading station
L Longitudinal direction

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for transshipping load carriers, in particular swap bodies and ISO containers, between road and rail, having a loading station comprising:
at least one platform for temporarily storing a series of load carriers in the longitudinal direction of the platform;
at least one road for trucks to drive up on one side of the platform; and
at least one track for a train to drive up on the other side of the platform, the method comprising:
providing the train for being loaded with load carriers at predetermined points along its longitudinal extension;
informing the loading station and/or an operator of the loading station before the train drives up regarding the points of the train provided for loading by load carriers,
wherein a plurality of trucks drive up to the platform one after the other via the road and in each case transferring at least one load carrier to sections of the platform corresponding to the points of the train to be loaded in a direction transverse to the longitudinal extension of the platform;
temporarily storing the load carriers transferred from the trucks to the platform at the sections of the platform corresponding to the points of the train to be loaded until the train drives up,
wherein the train is driven up to the platform and stopped next to the platform; and
transferring in each case the temporarily stored load carriers to the stopped train at points of the train provided for loading by load carriers in a direction transverse to the longitudinal extension of the platform.

2. The method of claim 1, further comprising:
providing a platform in each case in the loading station on both sides of the track for temporarily storing a series of load carriers in the longitudinal direction of the platform, and
preferably, providing a road for trucks to drive up on the sides of the platforms facing away from the track.

3. The method of claim 2,
wherein a plurality of trucks drive up to the platforms one after the other via the roads and in each case transferring at least one load carrier to sections of the platforms corresponding to the points of the train to be loaded in a direction transverse to the longitudinal extension of the assigned platform,
temporarily storing the load carriers transferred from the trucks to the platforms at the sections of the platforms corresponding to the points of the train to be loaded until the train drives up,
wherein the train is driven up to the platform and stopped next to the platforms,
transferring in each case the temporarily stored load carriers to the stopped train at points of the train provided for loading by load carriers in a direction transverse to the longitudinal extension of the assigned platform.

4. The method of claim 1,
wherein the width of the at least one platform transverse to the longitudinal extension of the platform is selected corresponding to at least substantially the width of the load carriers, and/or
wherein the transfer of the load carriers temporarily stored on at least one platform in a direction transverse to the longitudinal extension of the at least one platform are each transferred to the train at least substantially simultaneously at points of the train provided for loading by load carriers.

5. The method of claim 1,
stopping the train to be loaded with load carriers at predetermined points in an unloading station comprising at least one platform for temporarily storing load carriers, at least one track for the train to drive up on one side of the platform, and at least one road for trucks to drive up on the other side of the platform, and
transferring each of the load carriers provided for unloading to the platform at the unloading station in a direction transverse to the longitudinal extension of the platform.

6. The method of claim 5,
wherein the train is stopped in the unloading station to unload the load carriers provided for unloading at the platform before driving up to the loading station.

7. The method of claim 5,
wherein the load carriers transferred at the unloading station from the train to the platform are transferred one after the other to a plurality of trucks in a direction transverse to the longitudinal extension of the platform, and
wherein, preferably, at least one load carrier picked up in the unloading station by a truck is driven to the loading station and in the loading station is transferred to the platform of the loading station as a load carrier to be picked up by another train in a direction transverse to the longitudinal extension of the platform of the loading station.

8. The method of claim 5,
wherein a platform is provided in each case in the unloading station on both sides of the track for temporarily storing a series of load carriers in the longitudinal direction of the platform, and
wherein, preferably, a road for trucks to drive up is provided on the sides of the platforms facing away from the track.

9. The method of claim 8,
wherein the load carriers provided for unloading are each transferred to the platforms at the unloading station in a direction transverse to the longitudinal extension of the associated platform, and
wherein the load carriers transferred from the train to the platforms at the unloading station are transferred one after the other to a plurality of trucks in a direction transverse to the longitudinal extension of the assigned platform.

10. The method of claim 5,
wherein, in the unloading station, load carriers provided for loading are driven up to the at least one platform by at least one truck and transferred to the associated platform in a direction transverse to the longitudinal extension of the associated platform, and
wherein the load carriers provided for loading and transferred to the at least one platform in the unloading station are transferred to the train stopped in the unloading station in a direction transverse to the longitudinal extension of the at least one platform.

11. The method of claim 1,
wherein, in the loading station, two tracks for a train to drive up in each case are provided and one platform between the tracks,
wherein, preferably, one platform is provided in case each on the sides of the two tracks facing away from the platform between the two tracks, and
wherein, further preferably, one road for trucks to drive up is provided in each case on the sides, facing away from the two tracks, of the platforms provided on the sides of the tracks.

12. The method of claim 5,
wherein, in the unloading station, load carriers provided for loading are driven up to the at least one platform by a train and are transferred to the associated platform in a direction transverse to the longitudinal extension of the associated platform, and
wherein the load carriers provided for loading and transferred from the train to the at least one platform are transferred in the unloading station to a train subsequently stopped in the unloading station in a direction transverse to the longitudinal extension of the at least one platform.

13. The method of claim 1,
wherein, in the unloading station, two tracks for one train to drive up in each case are provided and one platform is provided between the tracks,
wherein, preferably, one platform is provided in case each on the sides of the two tracks facing away from the platform between the two tracks, and
wherein, further preferably, one road for trucks to drive up is provided in each case on the sides, facing away from the two tracks, of the platforms provided on the sides of the tracks.

14. The method of claim 1,
wherein, in the loading station, load carriers provided for loading are driven by a train to the at least one platform and transferred to the associated platform in a direction transverse to the longitudinal extension of the associated platform, and
wherein the load carriers provided for loading and transferred from the train to the at least one platform are transferred in the loading station to a train subsequently stopped in the loading station in a direction transverse to the longitudinal extension of the at least one platform.

15. The method of claim 5,
wherein at least one platform extends in the longitudinal extension of the platform, in particular all platforms in the longitudinal extension of the respective platform, continuously from the unloading station to the loading station or vice versa, and/or
wherein at least one track and at least one road extend along the longitudinal extension of at least one platform continuously from the unloading station to the loading station or vice versa.
